(19) United States
(12) Patent Application Publication
(10) Pub. No.: US 2006/0203798 A1
(43) Pub. Date: Sep. 14, 2006

(54) Telephone set, multimedia terminal and server

(76) Inventors: Fabien Astic, Paris (FR); Genevieve Larbre, Paris (FR); Pascal Le Guyadec, Paris (FR); Patrice Mignot, Versailles (FR); Thierry Samama, Paris (FR)

Correspondence Address: FULBRIGHT & JAWORSKI, LLP, 666 FIFTH AVE, NEW YORK, NY, 10103-3198, US

(21) Appl. No.: 10/530,105

(22) PCT Filed: Sep. 23, 2003
(86) PCT No.: PCT/FR03/50063

§ 371 Date: Apr. 1, 2005

(30) Foreign Application Priority Data
Oct. 4, 2002 (FR) 02/12357

(51) Int. Cl. H04L 12/66

(52) U.S. Cl. 370/352

(57) ABSTRACT

The invention concerns a telephone set associated with a multimedia terminal. Said set comprises means for ordering transmission, to a server comprising a database wherein are stored identifiers of telephone sets and identifiers of the multimedia terminals associated with said telephone sets, of a request in the form of a message including an identifier of said first telephone set and an identifier of a second telephone set with which the first set is currently communicating over the phone. The server comprises means for ordering transmission, to a multimedia terminal associated with the first and/or with the second telephone set, of an identifier of another terminal, so as to set up a multimedia communication, through a logical channel different from the telephone communication channel, between said multimedia terminals.

The present invention relates to a telephone set and to a multimedia terminal. It also concerns a process for placing in communication two multimedia terminals in the course of a telephone communication. It likewise relates to a server permitting two multimedia terminals to be placed in communication in the course of a telephone communication.

When two users are conversing by telephone they sometimes need, for the sake of better communication, to share multimedia data such as text, images or video. One telephone set does not generally permit sharing such multimedia data.

Terminals permitting the sharing of such data shall be referred to herein as “multimedia terminals.” These terminals are, for example, a computer or a television associated with a camera.

For such simultaneous multimedia voice and data communications one could resort to multimedia terminals alone, but such terminals and the associated logical channels are less effective than the associated logical stations and channels for conveying speech.

Thus, when two users are conversing by telephone communication, if they wish to exchange data they must, as the same time as their conversation, operate two computers connected in network, for example, via the IP channel.

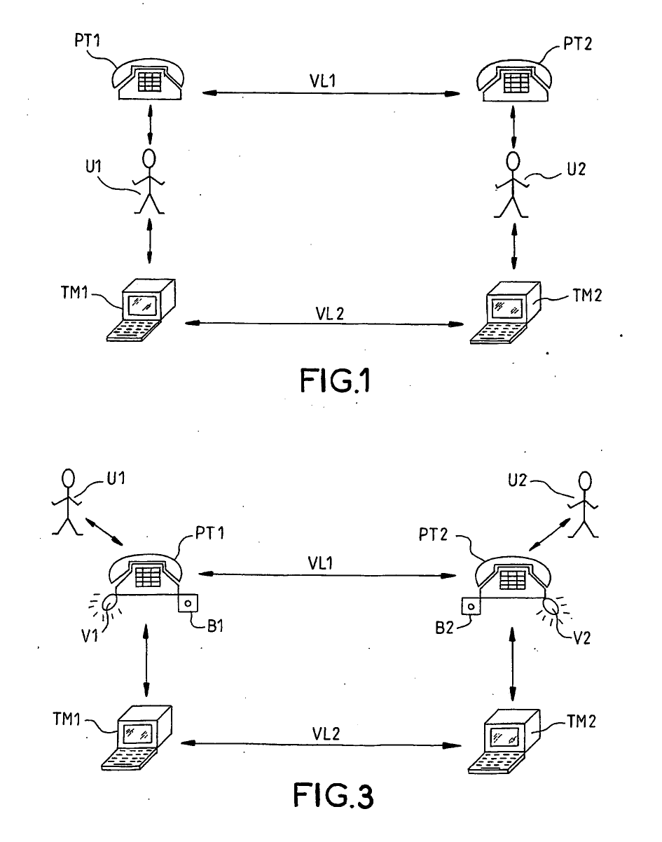

This problem of manipulation is illustrated by FIG. 1, which is schematic, representing an example of telephone communication through a logical VLI channel between two users U1 and U2, by means of two telephone sets PT1 and PT2.

If during a telephone communication, user U1, who will be named the “caller,” wishes to establish a multimedia communication from his multimedia terminal TMI via another logical channel VL2 to the multimedia terminal TM2 of the other user U2 who will be called the “called party,” the caller U1 must carry out several operations, including at least one entry of an identifier or address of the terminal TM2. A communication enabling the simultaneous sharing by the transfer of multimedia data, such as text, images or video shall be called “multimedia communication.”

This problem is presently solved in the case of telephony via the IP channel by a telephone set provided with means for transmitting the address of the second telephone set, during communication with the second set, to a multimedia terminal which is associated with the first set. When the terminal associated with the first set receives the address of the second set, this terminal communicates with this second set so as to obtain the address of the multimedia terminal associated with the second set and to establish multimedia communication with the terminal associated with this second set.

The present invention results from the finding that this solution cannot be directly transposed to the case of classical telephony through, for example, the public switched network, since the TMI terminal and telephone set PT2 cannot communicate directly with one another.

Moreover, this solution requires that a telephone set and its associated terminal be connected to one another, which involves interfacing costs between a telephone set and its associated terminal.

Lastly, this solution involves the establishment of a third communication between a distant telephone set and a multimedia terminal, in addition to two communications, telephone and multimedia, respectively.

The present invention remedies the difficulties mentioned above.

It concerns a telephone set characterized in that it includes means for initiating the transmission, to a server containing a data base in which identifiers of telephone sets and identifiers of the multimedia terminals associated with these telephone sets, of a request in the form of a message including an identifier of this first telephone set and an identifier of a second telephone set with which the first set is currently in telephone communication, the server containing means for sending to the multimedia terminal associated with the first and/or second telephone set an identifier of the other terminal, in order to establish a multimedia communication between these multimedia terminals through a logical channel distinct from the telephone communication channel.

The multimedia terminal which the user of the telephone set desires to use in order to establish a multimedia communication in the course of a telephone communication through the said telephone set, is called a multimedia terminal associated with a telephone set.

The identifier of a multimedia terminal is, for example, an address of this multimedia terminal. The identifier of a telephone set is, for example, the telephone number of this set.

Furthermore, two different logical channels, in one example, can correspond to the same physical channel on all or part of the way, but use different protocols for the transmission of data through this same physical channel.

Lastly, the data base containing identifiers of telephone sets and of associated multimedia terminals is organized such that the data of one identifier of one telephone set makes it possible to obtain an identifier of the multimedia terminal associated with this set.

Thus, the invention enables two parties to communicate via a channel optimized for the transmission of speech, while still establishing a multimedia communication in parallel.

Furthermore, the invention permits the use of an ordinary telephone system and does not necessarily require a physical connection between a set and its associated terminal.

The invention also permits the establishment, by very simple means, of a multimedia communication from an ongoing telephone conversation.

The invention therefore permits, for example, the conduct of a video conference, the sound being transmitted via the telephone communication, and the image via the multimedia communication, while the logical channels used for transmitting each type of data are optimized for each of these types.

In one embodiment, the message issued by this telephone set is an SMS (“short message service”) or an EMS (“enhanced message service”). Lastly, the invention also provides for the use of processes for data transmission, such as the DTMF (“dual tone multi-frequency”) process. Such embodiments offer the advantage of being simple and inexpensive to install, since they use known processes and protocols.

The multimedia communication command can be very easy for the user, for example by pressing a simple button on his telephone set.

In one embodiment, a telephone set according to the invention includes means for indicating to a user of this telephone set that he has the possibility of initiating the establishment of a multimedia communication with his answering party.

In fact, a multimedia communication according to the invention can be established only between two users having multimedia terminals and telephone sets including means for initiating the establishment of multimedia communication between these multimedia terminals.

The possibility of establishing multimedia communication with his answering party is indicated to the user by means, for example, of an indicator such as a pilot light which lights when multimedia communication is possible, or a message appearing on a screen suggesting the pressing of a specific button.

In another embodiment, the telephone set includes means for sending the server a recorded message containing an identifier of this telephone set and an identifier of a multimedia terminal associated with this telephone set, in order to be registered with this server.

In another embodiment, the telephone set includes the server containing a data base in which the identifiers of telephone sets and the identifiers of multimedia terminals associated with these telephone sets are stored. This embodiment offers the advantage of expediting communication between a set and the data base in which the identifiers of associated stations and terminals.

In another embodiment the telephone set includes particularly means for storing an identifier of an associated multimedia terminal.

According to a second aspect of the invention, which can be used independently of other arrangements of the invention, the telephone set includes means for:—sending to a second telephone set, when telephone communication is established with this second telephone set, a message containing an identifier of the multimedia terminal associated with the first set, and —receiving from a second telephone set, when a telephone communication is established with this second telephone set, a message containing an identifier of the multimedia terminal associated with this second set.

According to an embodiment of this second aspect of the invention, the telephone set comprises means for:—sending a request to a second telephone set, during a telephone conversation with this second set, to obtain a message including an multimedia terminal identifier associated with this second set, —sending a message to a second telephone set during a telephone conversation with this second telephone set, including an identifier of the multimedia terminal associated with the said telephone set, and —receiving from a second telephone set, in the course of a telephone conversation with this second telephone set, a message containing an identifier of the multimedia terminal associated with this second set.

In an embodiment of this second aspect of the invention, the telephone set includes means for sending to an associated first multimedia terminal a request including an identifier of a second telephone set or an identifier of a second multimedia terminal in order to establish a multimedia communication between this first multimedia terminal and this second multimedia terminal in the course of a telephone conversation with a second telephone set. Communication between the telephone set and the multimedia terminal is carried on, for example, according to the UPnP (“Universal Plug and Play”) protocol.

Furthermore, the invention also relates to a server characterized in that it includes a data base in which are stored identifiers of telephone sets and identifiers of the multimedia terminals associated with these telephone sets, and means for issuing, by a logical channel other than a telephone channel, an identifier of a second multimedia terminal associated with a second telephone set in order to initiate the establishment of multimedia communication between these two multimedia terminals, in response to a request by telephone from the first or second telephone set.

In one embodiment of the invention, the server includes means for: —receiving a recorded message including an identifier of a multimedia terminal and an identifier of an associated telephone set, and —recording these identifiers in the data base such that they are associated with one another.

A multimedia terminal whose identifier is included in a data base of such a server, associated with an identifier of a telephone set, is said to be “recorded” in this server. Likewise, a telephone set whose identifier is included in a data base of such server, associated with an identifier of a multimedia terminal, is said to be “recorded” with this server.

According to one embodiment of the invention, the server includes means for receiving requests from telephone sets via SMS and/or via EMS or via DMF.

Moreover, the invention also relates to a multimedia terminal, characterized in that it includes mens for establishing a multimedia communication with another multimedia terminal in response to a request from a server as defined above or in response to a request from an associated telephone set as defined above.

According to an embodiment, the multimedia terminal includes means for sending to a server a recorded message containing an identifier of this multimedia terminal, as well as an identifier of an associated telephone set, in order to record it with this server.

According to an embodiment of the invention, this multimedia terminal includes a server containing a data base in which are stored the identifiers of telephone sets and identifiers of the multimedia terminals associated with these telephone sets.

Furthermore, the invention relates to a multimedia communication command process from a telephone set in order to establish multimedia communication between a first terminal and a second terminal, associated respectively with a first and a second telephone set, through a logical channel distinct from the channel of the telephone communication, this process including the following steps:

The second telephone set sends a message containing an identifier of the second terminal, to the first telephone set, and —the first telephone set sends a message containing an identifier of the second multimedia terminal to the first multimedia terminal.

Lastly, the invention relates to a multimedia communications command process starting from a server in order to establish multimedia communications between a first and a second multimedia terminal associated respectively with a first and with a second telephone set, through a logical channel distinct from the telephone communications channel, this process comprising the following stages: —when the server receives a request from a first or from the second telephone set, this request containing the identifiers of the first and of the second telephone set, the server determines, by means of a data base, the identifiers of these first and second multimedia terminals associated with the identifiers of these first and second telephone sets, and —when the server has determined these identifiers of multimedia terminals, it sends a message including the identifier of the first terminal to the second terminal, and/or it sends a message including the identifier of the second terminal to the first terminal.

Other features and advantages of the invention will appear from the description given below, by way of description not limitation, referring to the following figures:

FIG. 1, already described, is a scheme representing an example of telephone communication between two users through two telephone sets, parallel to a multimedia communication between these two users;

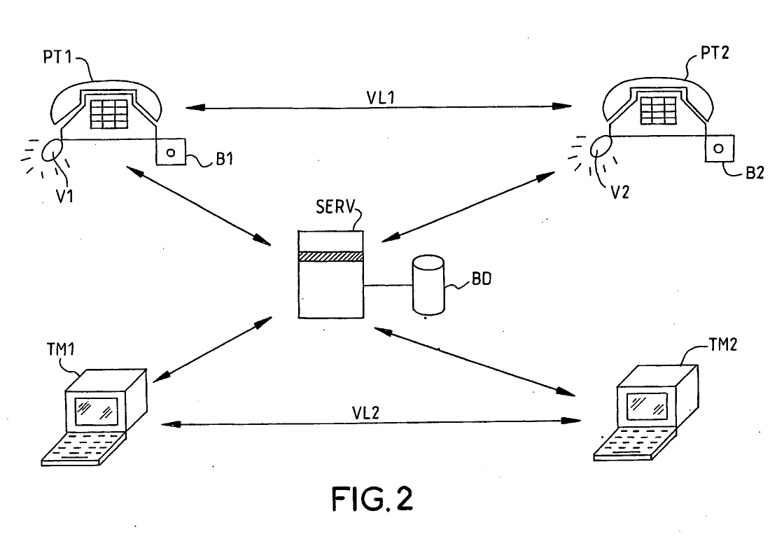

FIG. 2 represents schematically the setup according to one embodiment of the invention of a multimedia communication parallel to a telephone communication; and

FIG. 3 represents schematically the establishment, with a terminal according to the invention, of a multimedia communication parallel to a telephone communication.

In FIG. 2 there is shown schematically two telephone sets PT1 and PT2 connected by the public telephone network (Logic Channel VL1).

Two multimedia terminals TM1 and TM2 are associated with telephone sets PT1 and PT2 respectively.

Terminals TM1 and TM2 are connected to one another through another logical channel VL2 which is, for example, the IP (“Internet Protocol”).

Furthermore, a server SERV is connected to the telephone sets PT1 and PT2 through the public telephone system (logical channel VLL) and to the multimedia channels TM1 and TM2 through the IP channel (logical channel VL2).

Each telephone set PT1, PT2 has a button B1, B2, to initiate the establishment of a multimedia communication between the multimedia terminals TM1 and TM2.

Lastly, the server SERV includes a data base BD which contains a list of telephone set numbers and IP addressed of multimedia terminals, each telephone number being associated with an IP address.

This database BD includes particularly the telephone set number PT1 associated with the IP address of the multimedia terminal TM1 as well as the telephone set number PT2 associated with the IP address of multimedia terminal TM2.

These data were transmitted to the server SERV, which stored them in the data base BD, by the multimedia terminals TM1 and TM2, during a previous recording phase.

At the time of this recording phase, the multimedia terminal TM1 (TM2) available for user U1 (U2) sends the server (SERV) a message containing the IP address of the terminal TM1 (TM2) as well as the number of telephone set PT1 (PT2) which is likewise available for user U1 (U2).

During a telephone conversation between the two users U1 and U2, if user U1 of telephone set PT1 desires to share multimedia data, such as an image, with user U2 of telephone set PT2, he presses the button B1 of his telephone set.

Pressing the button B1 produces automatic transmission to the server SERV, through the multimedia terminal TM1, of a message, according to the SMS or EMS protocol or by DTMF pulses, of a request for establishment of multimedia communication containing the numbers of telephone sets PT1 and PT2.

The server SERV searches the data base BD for the IP addresses of multimedia terminals TM1 and TM2 associated with the numbers of telephone sets PT1 and PT2, transmitted by the message SMS or EMS sent by telephone set PT1.

Having the IP addresses of the multimedia terminals TM1 and TM2, the server SERV actuates the establishment of multimedia communication between these two terminals through an IP channel different from the channel VL1 taken by the telephone communication.

Thus, the two parties communicate through the medium of a telephone channel optimized for the transmission of speech and establishing in the simplest possible way (by the simple pressing of a button) a parallel multimedia communication, without any telephone set directly connected to its associated terminal, and without having to establish a supplemental communication between a terminal and a set.

In one embodiment, the set PT1 or PT2 sends at the end of the communication a message, for example SMS or EMS, indicating the end of communication, and this so as to assure the end of communication between terminals TM1 and TM 2.

In FIG. 3, which concerns another embodiment which does not resort to a server, two telephone sets PT1 and PT2 are represented schematically, connected through a logical channel VL 1, which is for example the public telephone network.

Two multimedia terminals TM1 and TM2 are also connected to one another through another logical channel VL2 which is, for example, the IP (“Internet Protocol”) channel.

Each telephone set PT1, PT2 has a button B1, B2 to establish multimedia communication between the multimedia terminals TM1 and TM2.

Moreover, each telephone set PT1, PT2, likewise has an indicator light V1, V2, or a message display to advise a user U1, U2 of this set whether his other party U2, U1, also is able to start the establishment of multimedia communication.

When a telephone communication is established between the telephone sets PT1 and PT2, telephone set PT1 automatically emits to set PT2 a message including the IP address of the multimedia terminal TM1 to which he is connected, and telephone set PT2 emits automatically a message to telephone set PT1 including the IP address of the multimedia terminal TM2 to which he is connected.

The reception by telephone set PT1 of the message including the IP address of the multimedia terminal TM2 turns on the indicator light V1 on telephone set PT1. Likewise, reception by telephone set PT2 of the message containing the IP address of multimedia terminal TM1 turns on the indicator light V2 on telephone set PT2.

So, when user U1 of telephone set PT1 wishes to share multimedia data such as an image with the User U2 of telephone set PT2, he presses the button B1 on his telephone set.

Pressing the button B1 causes a request to be sent to the multimedia terminal TM1 by the telephone set PT1 for the establishment of multimedia communication containing the IP address of the multimedia terminal TM2.

The reception by the multimedia terminal TM1 of a request including the IP address of the multimedia terminal TM2 initiates the establishment of multimedia communication between the multimedia terminals TM1 and TM2 through the IP channel VL2.

Thus, the two parties communicate through the medium of a telephone channel optimized for the transmission of speech and establish in the simplest possible manner (by the simple pressing of a button) a multimedia communication in parallel.

In another embodiment of the invention the multimedia terminal TM1 contains a data base containing telephone set numbers associated with IP addresses of multimedia terminals. This data base contains particularly the number of set PT2 associated with the IP address of terminal TM2.

Pressing the button B1 causes the sending of a request to the multimedia terminal by the telephone set PT1 for the establishment of multimedia communication comprising the number of set PT1.

Upon the reception by the terminal TM1 of a request for the establishment of multimedia communication containing the number of set PT2, the terminal TM1 searches the data base that contains the IP address of terminal TM2 associated with the number of set PT2.

Terminal TM1 then initiates the establishment of a multimedia communication between the multimedia terminals TM1 and TM2 via the IP channel VL2.

1-15. (canceled)

16. A telephone set comprising a transmitter for transmitting a request to a server, said request is a message comprising an identifier of a first telephone set and an identifier of a second telephone set in telephone communication with said first telephone set; and wherein said server comprises a database for storing identifiers of telephone sets and identifiers of multimedia terminals associated with said telephone sets, and a transmitter for transmitting to a multimedia terminal associated with said first telephone set and/or said second telephone set an identifier of other multimedia terminal to establish a multimedia communication between said multimedia terminals via a logical channel distinct from a telephone communication channel between said first telephone set and said second telephone set.

17. The telephone set of claim 16, wherein said logical channel is an IP channel.

18. The telephone set of claim 16, wherein said message is at least one of the following: a short message service (SMS), enhanced message service (EMS) or dual tone multi-frequency (DTMF) message.

19. The telephone set of claim 16, further comprising a indicator for indicating whether said multimedia communication can be initiated.

20. The telephone set of claim 16, further comprising a transmitter for transmitting to a server, a recorded message containing an identifier of a telephone set and an identifier of a multimedia terminal associated with said telephone set.

21. The telephone set of claim 16, further comprising a server, said server comprising a database for storing said identifiers of said telephone sets and said identifiers of said multimedia terminals associated with said telephone sets.

22. A server comprising a database for storing identifiers of telephone sets and identifiers of multimedia terminals associated with said telephone sets and a transmitter for transmitting to a first multimedia terminal associated with a first telephone set an identifier of a second multimedia terminal associated with a second telephone set via a logical channel to establish a multimedia communication between said first multimedia terminal and said second multimedia terminal in response to a request from said first or second telephone set via a telephone channel, and wherein said logical channel is distinct from said telephone channel.

23. The server of claim 22, wherein said logical channel is an IP channel.

24. The server of claim 22, further comprising a receiver for receiving a recorded message comprising an identifier of a multimedia terminal and an identifier of an associated telephone set, and wherein said database is operable to record said identifiers.

25. The server of claim 22, further comprising a receiver for receiving requests from telephone sets via at least one of the following: short message service (SMS), enhanced message service (EMS) or dual tone multi-frequency (DTMF) channels.

26. A multimedia terminal comprising a device for establishing a multimedia communication with another multimedia terminal in response to a request from said server of claim 22.

27. The multimedia terminal of claim 26, further comprising a transmitter for transmitting to said server a recorded message, wherein said recorded message comprises an identifier of said multimedia terminal and an identifier of an associated telephone set.

28. The multimedia terminal of claim 26, further comprising a database for storing identifiers of telephone sets and identifiers of multimedia terminals associated with said telephone sets.

29. A method of initiating multimedia communications between multimedia terminals associated with telephone sets via a logical channel distinct from a telephone communications channel, comprising the steps of:
sending a request comprising identifiers of a first and a second telephone sets to a server by said first telephone set or said second telephone set;
determining identifiers of a first and a second multimedia terminals associated with said identifiers of said first and said second telephone sets from a database by said server; and
transmitting at least one of the following by said server: a message to said first multimedia terminal comprising said identifier of said second multimedia terminal or a message to said second multimedia terminal comprising said identifier of said first multimedia terminal.

30. The method for initiating multimedia communications of claim 29, wherein the logical channel is an IP channel; and wherein said first and said second multimedia terminals establish multimedia communications over said IP channel.
